(19) United States
(12) Patent Application Publication
(10) Pub. No.: US 2006/0112594 A1
(43) Pub. Date: Jun. 1, 2006

(54) Method of manufacturing an upper for an article of footwear

(75) Inventor: Bruce J. Kilgore, Lake Oswego, OR (US)

Correspondence Address: BANNER & WITCOFF, LTD., 28 STATE STREET, 28th FLOOR, BOSTON, MA, 02109-9601, US

(73) Assignee: Nike, Inc., Beaverton, OR (US)

(21) Appl. No.: 11/001,289

(22) Filed: Dec. 1, 2004

(51) Int. Cl. A43B 23/00; B32B 38/04; B32B 37/14; B65D 65/28

(52) U.S. Cl. 36/45; 156/250; 156/73.1; 156/272.2; 428/43

(57) ABSTRACT

A method of forming an upper for an article of footwear includes the steps of providing an exterior layer of an upper of an article of footwear having a layer of adhesive secured to an interior surface thereof, positioning an interior layer of the upper in contact with the interior surface of the exterior layer, applying heat and pressure to laminate the interior layer and exterior layer together, and cutting the laminated interior layer and exterior layer to a desired final form.

### FIELD OF THE INVENTION

This invention relates generally to an upper for an article of footwear, and, in particular, to an improved method of manufacturing an upper for an article of footwear.

### BACKGROUND OF THE INVENTION

Uppers for articles of footwear necessarily have complex shapes, since they must wrap around the contours of the human foot. Known methods of manufacturing uppers involve numerous fabrication steps and may include the use of multiple pieces of material in order to form a complete upper. The use of multiple pieces results in seams, which can produce irritation points and areas of discomfort for the user.

It is an object of the present invention to provide a method of manufacturing an upper for an article of footwear, or at least a portion of an upper, that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide an improved method of manufacturing an upper for an article of footwear.

In accordance with a first preferred embodiment, a method of forming a portion of an upper for an article of footwear includes the steps of providing an exterior layer of an upper of an article of footwear having a layer of adhesive secured to an interior surface thereof, positioning an interior layer of the upper in contact with the interior surface of the exterior layer, applying heat and pressure to laminate the interior layer and exterior layer together, and cutting the laminated interior layer and exterior layer to a desired final form.

In accordance with another preferred embodiment, a method of forming a portion of an upper for an article of footwear includes the steps of providing an exterior layer of an upper of an article of footwear having a layer of adhesive secured to an interior surface thereof in a substantially flat configuration, positioning an interior layer of the upper of an article of footwear in contact with the interior surface of the exterior layer, applying heat and pressure to laminate the interior layer and exterior layer together, and cutting the laminated interior layer and exterior layer to a desired final form.

In accordance with a further preferred embodiment, a method of forming a portion of an upper for an article of footwear includes the steps of providing a roll of material having an adhesive laminated to an inner surface thereof, cutting a piece of material from the roll of material to form an exterior layer of an upper, the adhesive disposed on an interior surface of the exterior layer, cutting at least one aperture in a selected area of the exterior layer, placing a selected quantity of reinforcing elements on the interior surface of the exterior layer, placing a selected quantity of cushioning elements on the interior surface of the exterior layer, and positioning an interior layer of the upper in contact with the interior surface of the exterior layer such that the reinforcing elements and cushioning elements are positioned between the interior layer and the exterior layer; applying heat and pressure to laminate the interior layer and the exterior layer together, and cutting the laminated interior layer and exterior layer to a desired final form.

In accordance with yet another preferred embodiment, a method of forming a portion of an upper for an article of footwear including the steps of providing an exterior layer of an upper of an article of footwear, positioning an interior layer of the upper in contact with a interior surface of the exterior layer, welding the interior layer and exterior layer together, and cutting the laminated interior layer and exterior layer to a desired final form.

In accordance with yet a further preferred embodiment, a method of forming a portion of an upper for an article of footwear includes the steps of cutting a piece of material from a roll of material to form an exterior layer of an upper; removing a portion of material from a selected area of the exterior layer; placing a selected quantity of reinforcing elements on the interior surface of the exterior layer; placing a selected quantity of cushioning elements on the interior surface of the exterior layer; positioning an interior layer of the upper in contact with the interior surface of the exterior layer such that the reinforcing elements and cushioning elements are positioned between the interior layer and the exterior layer; welding the interior layer to the exterior layer; and cutting the laminated interior layer and exterior layer to a desired final form.

Substantial advantage is achieved by providing an improved method of forming a portion of an upper for an article of footwear. In particular, preferred embodiments of the present invention can provide an upper for an article of footwear having reduced irritation points and offer considerable flexibility to influence performance attributes including support, breathability, and reduced weight without restricting aesthetics, and that can be produced in a method that reduces the number of fabrication steps.

These and additional features and advantages of the invention disclosed here will be further understood from the following detailed disclosure of certain preferred embodiments.

### BRIEF DESCRIPTION OF THE DRAWINGS

FIG. 1 is a perspective view of a roll of material from which a first layer of an upper manufactured in accordance with a preferred embodiment of the present invention is cut.

FIG. 2 is an exploded view of the components of an upper manufactured in accordance with a preferred embodiment of the present invention.

FIG. 3 is a perspective view of the components of FIG. 2, shown in an assembled condition as an upper in an intermediate stage of manufacture.

FIG. 4 is a perspective view of the upper of FIG. 3, shown after a final cutting step.

FIG. 5 is a perspective view of an alternative embodiment of an upper in accordance with the present invention.

FIG. 6 a perspective view of another alternative embodiment of an upper in accordance with the present invention.

The figures referred to above are not drawn necessarily to scale and should be understood to provide a representation of the invention, illustrative of the principles involved. Some features of the method of manufacturing an upper for an article of footwear depicted in the drawings have been enlarged or distorted relative to others to facilitate explanation and understanding. The same reference numbers are used in the drawings for similar or identical components and features shown in various alternative embodiments. Methods of manufacturing an upper for an article of footwear as disclosed herein would have configurations and components determined, in part, by the intended application and environment in which they are used.

### DETAILED DESCRIPTION OF CERTAIN PREFERRED EMBODIMENTS

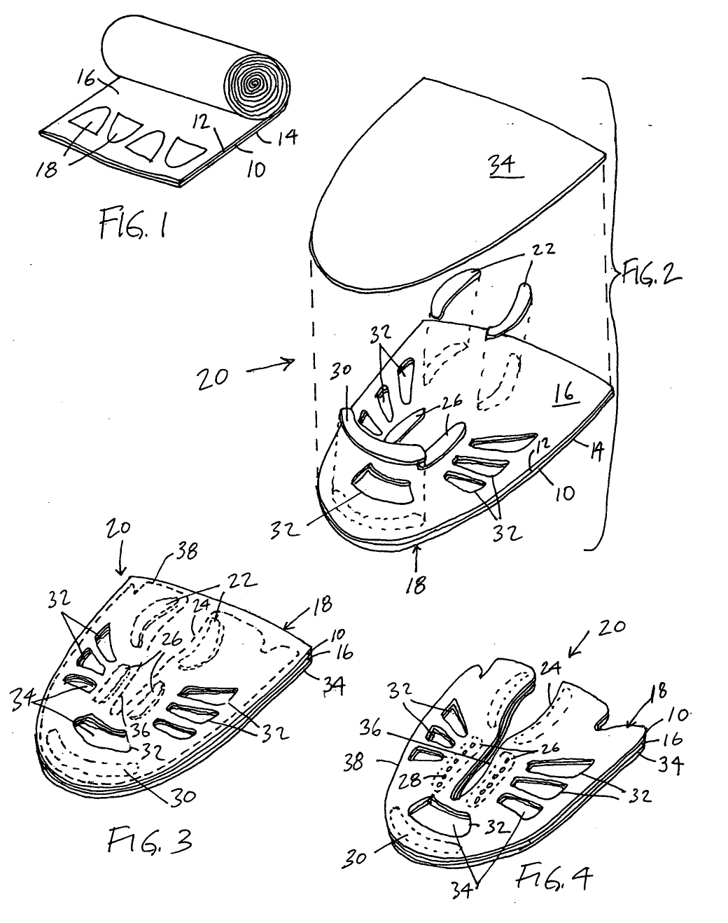

The present invention may be embodied in various forms. A preferred embodiment of a method of manufacturing an upper is illustrated in FIGS. 1-4. As can be seen in FIG. 1, a roll of material 10 has a first or interior surface 12 and a second or exterior surface 14. A layer of adhesive 16 is applied, by lamination or other suitable means, to interior surface 12. In a preferred embodiment, adhesive 16 is a hot-melt adhesive such as a thermoplastic polyurethane (TPU) based adhesive. A release liner (not shown) may be applied to the exposed surface of adhesive 16 in certain embodiments to prevent inadvertent adhesion of material 10 to other surfaces. In certain embodiments, adhesive layer 16 may be formed of a series of microdots rather than a contiguous layer of adhesive, which would provide additional breathability for a shoe upper 20 (seen in FIGS. 2-4).

An exterior layer 18 of shoe upper 20 is cut from material 10, with adhesive layer 16 forming the interior surface of exterior layer 18. As illustrated here, a plurality of exterior layers 18 are cut from material 10. It is to be appreciated the exterior layers 18 may be cut from material 10 in any suitable manner, including die-cutting, laser cutting, etc. It is to be further appreciated that the plurality of exterior layers 18 may be cut from material 10 simultaneously in order to improve efficiency.

In the embodiment described above, adhesive 16 is applied to material 10 before exterior layers 18 are cut out. In other embodiments, adhesive 16 could be applied individually to each exterior layer 18 at a later stage in the manufacturing process, e.g., after being cut from material 10.

One or more cushioning and/or support elements may be included in upper 20. As seen in FIG. 2, a plurality of cushioning and/or support elements may be placed on the adhesive layer 16 on the interior surface of exterior layer 18. In the illustrated embodiment, a pair of cushioning elements 22 is positioned on adhesive layer 16, opposed from one another in a location that will form opposed sides of an ankle opening 24 in upper 20 (seen in FIG. 4) once upper 20 is cut to its final form. Cushioning elements 22 will serve to provide cushioning and support around the ankle of the user. Cushioning elements 22 may be formed of a foam material, a polyester material, a non-woven material, or any other material suitable for providing a cushioning effect about a user's foot.

A pair of reinforcing elements 26 is also positioned on adhesive layer 16, with each reinforcing element 26 being positioned where eyelets 28 will be formed (seen in FIG. 4). Reinforcing elements 26 provide support for eyelets 28 when they are laced and help to prevent ripping or tearing of eyelets 28. Reinforcing elements 26 may be formed, for example, of plastic.

A reinforcing element 30 is seen in FIG. 2 being positioned in the toe region of upper 20, providing reinforcing where the footwear can see significant wear. Reinforcing element 30 may also be formed, for example, of plastic. It is to be appreciated that the reinforcing and cushioning elements illustrated here are only exemplary. Reinforcing and cushioning elements can be positioned at any desired location on exterior layer 18. The type, location, and number of reinforcing and cushioning elements used can be based on numerous factors including, for example, the activity to be engaged in by the user of the footwear and the shape of the user's foot. It is to be appreciated that in certain embodiments there may not be any reinforcing elements provided between exterior layer 18 and interior layer 34, and that in certain embodiments there may not be any cushioning elements provided between exterior layer 18 and interior layer 34.

In certain embodiments, material may be removed from certain portions of exterior layer 18 to provide enhanced ventilation and breathability in upper 20 when it is assembled, and to reduce the weight of the upper. In the illustrated embodiment, a plurality of apertures 32 is cut in exterior layer 18. Apertures 32 are preferably positioned in areas of upper 20 that do not provide support functions. In the illustrated embodiment three apertures 32 are formed in the lateral and medial sides of exterior layer 18, and a single aperture 32 is formed in the toe portion of exterior layer 18. It is to be appreciated that any number of apertures may be cut in exterior layer 18, and that the apertures may be located in any desired location.

Once the desired reinforcing and support elements have been put in place and the desired apertures have been cut in exterior layer 18, an interior layer 34 of upper 20 is secured or bonded to exterior layer 18. In a preferred embodiment, heat and pressure is applied to the combination of exterior layer 18, adhesive layer 16, and interior layer 34, producing an upper 20 as seen in FIG. 3. It is noted that as seen in FIG. 2, exterior layer 18 is positioned beneath interior layer 34. As seen in FIG. 3, upper 20 has been inverted, and exterior layer 18 is positioned above interior layer 34, in an orientation as it appears in final form on an article of footwear. In this orientation, it can be seen that interior layer 34, which forms a lining for upper 20 extends beneath apertures 32. Interior layer 32 is preferably a fabric material that allows air to pass through, thereby enhancing ventilation of upper 20.

It can be seen that apertures 32 expose interior layer 34. Heat and pressure may be applied to exterior layer 18 and interior layer 34 of upper 20 byway of a heat press or other suitable device.

The final step in the manufacture of upper 20 includes cutting upper 20 to a desired final shape, as depicted in FIGS. 3-4. At this step, any cuts that are required to extend through exterior layer 18, adhesive layer 16, and interior layer 34 are made. Eyelets 28 are cut at this stage, as is ankle opening 24 and a tongue opening 36 in which the tongue (not shown) of the footwear is positioned. The peripheral edge 38 of upper 20 is also cut to its final form at this step. Eyelets 28, ankle opening 24, tongue opening 36 and peripheral edge 38 are shown with dashed lines in FIG. 3. The final cuts of upper 20 may be made by die cutting, laser cutting, water jet cutting, or any other suitable cutting means.

By manufacturing upper 20 in a flat condition, the overall number of pieces of upper 20 can be reduced, and the added cushioning and reinforcement elements can be accurately placed in their correct position, thereby resulting in an improved final product.

Another embodiment of upper 20 is shown in FIG. 5. In this embodiment, in addition to adhesive layer 16, stitching is used to secure exterior layer 18 to interior layer 34. In the illustrated embodiment, stitching 40 is provided about the circumference of apertures 32. Stitching 40 advantageously provides additional reinforcement in desired locations of upper 20. It is to be appreciated that stitching 40 can be provided at any desired location on upper 20.

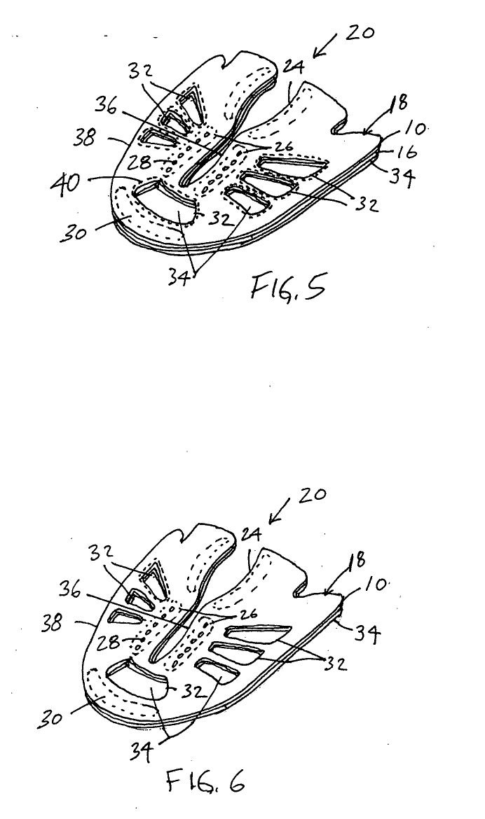

Another preferred embodiment is shown in FIG. 6, in which exterior layer 18 is bonded to interior layer 34 by welding rather than a layer of adhesive. In such an embodiment, once the preliminary cuts to remove selected material from exterior layer 18 have been made, cushioning elements 22 and reinforcing elements 26, 30 are positioned between exterior layer 18 and interior layer 34, and then the layers are welded together. Various welding methods may be used including, for example, laser welding, sonic welding, ultrasonic welding and RF welding. Once exterior layer 18 and interior layer 34 have been welded to one another, the desired final cut is made, as described above in connection with FIGS. 3-4.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A method of forming a portion of an upper for an article of footwear comprising the following steps, in combination:
providing an exterior layer of an upper of an article of footwear having a layer of adhesive secured to an interior surface thereof;
positioning an interior layer of the upper in contact with the interior surface of the exterior layer;
applying heat and pressure to laminate the interior layer and exterior layer together; and
cutting the laminated interior layer and exterior layer to a desired final form.

2. The method of claim 1, further comprising the step of removing material from selected areas of the exterior layer prior to positioning the interior layer in contact with the interior surface.

3. The method of claim 2, wherein material is removed from a forefoot portion of the exterior layer.

4. The method of claim 2, wherein material is removed from a lateral side of the exterior layer.

5. The method of claim 2, wherein material is removed from a medial side of the exterior layer.

6. The method of claim 1, further comprising the step of placing a selected quantity of reinforcing elements on the interior surface prior to positioning the interior layer in contact with the interior surface, the reinforcing elements being positioned between the interior layer and the exterior layer.

7. The method of claim 6, wherein reinforcing elements are placed in an area of the exterior layer where eyelets are positioned.

8. The method of claim 6, wherein reinforcing elements are placed in a toe portion of the exterior layer.

9. The method of claim 1, further comprising the step of placing a selected quantity of cushioning elements on the interior surface prior to positioning the interior layer in contact with the interior surface, the cushioning elements being positioned between the interior layer and the exterior layer.

10. The method of claim 9, wherein cushioning elements are placed in an area of the exterior layer that will form an ankle opening.

11. The upper of claim 66, wherein the layer of adhesive comprises a plurality of microdots of adhesive.

12. The method of claim 1, wherein the step of cutting the laminated interior layer and exterior layer includes cutting eyelets.

13. The method of claim 1, wherein the step of cutting the laminated interior layer and exterior layer includes cutting an ankle opening.

14. The method of claim 1, wherein the step of cutting the laminated interior layer and exterior layer includes cutting an opening for a tongue.

15. The method of claim 1, wherein the adhesive is a hot-melt adhesive.

16. The method of claim 1, wherein the step of cutting is performed with a laser.

17. The method of claim 1, wherein the step of cutting is performed by die-cutting.

18. The method of claim 1, wherein the step of cutting is performed with a water jet.

19. The method of claim 1, further comprising the step of stitching selected portions of the exterior layer to the interior layer.

20. The method of claim 1, wherein the layer of adhesive comprises a plurality of microdots of adhesive.

21. A method of forming a portion of an upper for an article of footwear comprising the following steps, in combination:
providing an exterior layer of an upper of an article of footwear having a layer of adhesive secured to an interior surface thereof in a substantially flat configuration;
positioning an interior layer of the upper of an article of footwear in contact with the interior surface of the exterior layer;
applying heat and pressure to laminate the interior layer and exterior layer together; and cutting the laminated interior layer and exterior layer to a desired final form.

22. The method of claim 21, further comprising the step of removing material from selected areas of the exterior layer prior to positioning the interior layer in contact with the interior surface.

23. The method of claim 21, further comprising the step of placing a selected quantity of reinforcing elements on the interior surface prior to positioning the interior layer in contact with the interior surface, the reinforcing elements being positioned between the interior layer and the exterior layer.

24. The method of claim 21, further comprising the step of placing a selected quantity of cushioning elements on the interior surface prior to positioning the interior layer in contact with the interior surface, the cushioning elements being positioned between the interior layer and the exterior layer.

25. The method of claim 21, wherein the step of cutting the laminated interior layer and exterior layer includes cutting eyelets.

26. The method of claim 21, wherein the step of cutting the laminated interior layer and exterior layer includes cutting an ankle opening.

27. The method of claim 21, wherein the step of cutting the laminated interior layer and exterior layer includes cutting an opening for a tongue.

28. The method of claim 21, further comprising the step of stitching selected portions of the exterior layer to the interior layer.

29. The method of claim 21, wherein the layer of adhesive comprises a plurality of microdots of adhesive.

30. A method of forming a portion of an upper for an article of footwear comprising the following steps, in combination:
providing a roll of material having an adhesive laminated to an inner surface thereof;
cutting a piece of material from the roll of material to form an exterior layer of an upper, the adhesive disposed on an interior surface of the exterior layer;
cutting at least one aperture in a selected area of the exterior layer;
placing a selected quantity of reinforcing elements on the interior surface of the exterior layer;
placing a selected quantity of cushioning elements on the interior surface of the exterior layer;
positioning an interior layer of the upper in contact with the interior surface of the exterior layer such that the reinforcing elements and cushioning elements are positioned between the interior layer and the exterior layer;
applying heat and pressure to laminate the interior layer and the exterior layer together; and
cutting the laminated interior layer and exterior layer to a desired final form.

31. A method of forming a portion of an upper for an article of footwear comprising the following steps, in combination:
providing an exterior layer of an upper of an article of footwear;
positioning an interior layer of the upper in contact with a interior surface of the exterior layer;
welding the interior layer and exterior layer together; and
cutting the laminated interior layer and exterior layer to a desired final form.

32. The method of claim 31, wherein the step of welding is performed by laser welding.

33. The method of claim 31, wherein the step of welding is performed by sonic welding.

34. The method of claim 31, wherein the step of welding is performed by ultrasonic welding.

35. The method of claim 31, wherein the step of welding is performed by RF welding.

36. The method of claim 31, further comprising the step of removing material from selected areas of the exterior layer prior to positioning the interior layer in contact with the interior surface.

37. The method of claim 31, further comprising the step of placing a selected quantity of reinforcing elements on the interior surface prior to positioning the interior layer in contact with the interior surface, the reinforcing elements being positioned between the interior layer and the exterior layer.

38. The method of claim 31, further comprising the step of placing a selected quantity of cushioning elements on the interior surface prior to positioning the interior layer in contact with the interior surface, the cushioning elements being positioned between the interior layer and the exterior layer.

39. A method of forming a portion of an upper for an article of footwear comprising the following steps, in combination:
cutting a piece of material from a roll of material to form an exterior layer of an upper;
removing a portion of material from a selected area of the exterior layer;
placing a selected quantity of reinforcing elements on the interior surface of the exterior layer;
placing a selected quantity of cushioning elements on the interior surface of the exterior layer;
positioning an interior layer of the upper in contact with the interior surface of the exterior layer such that the reinforcing elements and cushioning elements are positioned between the interior layer and the exterior layer;
welding the interior layer to the exterior layer; and
cutting the laminated interior layer and exterior layer to a desired final form.

40. The method of claim 39, wherein the step of welding is performed by laser welding.

41. The method of claim 39, wherein the step of welding is performed by sonic welding.

42. The method of claim 39, wherein the step of welding is performed by ultrasonic welding.

43. The method of claim 39, wherein the step of welding is performed by RF welding.

44. A method of forming a portion of an upper for an article of footwear comprising the following steps, in combination:
providing an exterior layer of an upper of an article of footwear;
providing an interior layer of an upper of an article of footwear;
placing a selected quantity of reinforcing elements between an interior surface of the exterior layer and an interior surface of the interior layer;
placing a selected quantity of cushioning elements between the interior surface of the exterior layer and the interior surface of the interior layer;
bonding the interior layer and the exterior layer together; and
cutting the bonded interior layer and exterior layer to a desired final form.

45. The method of claim 44, wherein the step of bonding is performed by positioning an adhesive layer between the interior layer and the exterior layer and applying heat and pressure to laminate the interior layer and exterior layer together.

46. The method of claim 44, wherein the step of bonding is performed by welding.

47. The method of claim 44, wherein the step of welding is performed by laser welding.

48. The method of claim 44, wherein the step of welding is performed by sonic welding.

49. The method of claim 44, wherein the step of welding is performed by ultrasonic welding.

50. The method of claim 44, wherein the step of welding is performed by RF welding.

51. An upper of an article of footwear comprising, in combination:
an exterior layer having an interior surface;
a layer of adhesive secured to the interior surface of the exterior layer; and
an interior layer positioned in contact with layer of adhesive on the interior surface of the exterior layer and laminated to the exterior layer with the application of heat and pressure; wherein the laminated interior layer and exterior layer are cut to a desired final form.

52. The upper of claim 51, further comprising at least one aperture in the exterior layer formed by removing material from a selected area of the exterior layer prior to positioning the interior layer in contact with layer of adhesive on the interior surface of the exterior layer.

53. The upper of claim 51, further comprising at least one reinforcing element positioned between the interior layer and the exterior layer.

54. The upper of claim 51, further comprising at least one cushioning element positioned between the interior layer and the exterior layer.

55. The upper of claim 51, further comprising a plurality of eyelets formed by cutting through the exterior layer and the interior layer.

56. The upper of claim 51, further comprising stitching securing a portion of the exterior layer to the interior layer.

57. The upper of claim 51, wherein the cutting of the interior layer and exterior layer is performed by one of a laser, die-cutting, and a water jet.

58. The upper of claim 51, wherein the layer of adhesive comprises a plurality of microdots of adhesive.

59. An upper of an article of footwear comprising, in combination:
an exterior layer having an interior surface; and
an interior layer positioned in contact with the interior surface of the exterior layer and welded to the exterior layer; wherein the welded interior layer and exterior layer are cut to a desired final form.

60. The upper of claim 59, wherein the welding of the interior layer to the exterior layer is performed by one of laser welding, sonic welding, ultrasonic welding, and RF welding.

61. The upper of claim 59, further comprising at least one aperture in the exterior layer formed by removing material from a selected area of the exterior layer prior to positioning the interior layer in contact with the interior surface of the exterior layer.

62. The upper of claim 59, further comprising at least one reinforcing element positioned between the interior layer and the exterior layer.

63. The upper of claim 59, further comprising at least one cushioning element positioned between the interior layer and the exterior layer.

64. The upper of claim 59, further comprising a plurality of eyelets formed by cutting through the exterior layer and the interior layer.

65. The upper of claim 59, further comprising stitching securing a portion of the exterior layer to the interior layer.

66. An upper of an article of footwear comprising, in combination:
an exterior layer having an interior surface;
a layer of adhesive on the interior surface of the exterior layer; and
an interior layer secured to the exterior layer with the layer of adhesive.

67. The upper of claim 66, further comprising at least one aperture formed in the exterior layer.

68. The upper of claim 66, further comprising at least one reinforcing element positioned between the interior layer and the exterior layer.

69. The upper of claim 66, further comprising at least one cushioning element positioned between the interior layer and the exterior layer.

70. The upper of claim 66, further comprising a plurality of eyelets extending through the exterior layer and the interior layer.

71. The upper of claim 66, further comprising stitching securing a portion of the interior layer to a portion of the exterior layer.

72. (canceled)
